(19) United States
(12) Patent Application Publication
(10) Pub. No.: US 2014/0204426 A1
(43) Pub. Date: Jul. 24, 2014

(54) METHOD AND APPARATUS FOR CORRECTING A PRINTED IMAGE

(71) Applicant: DIP-TECH LTD., Kfar Sava (IL)

(72) Inventor: Yaakov Levi, Kfar Yona (IL)

(21) Appl. No.: 14/342,717

(22) PCT Filed: Oct. 22, 2012
(86) PCT No.: PCT/IL2012/000366

§ 371 Date: Mar. 4, 2014

Related U.S. Application Data
(60) Provisional application No. 61/554,640, filed on Nov. 2, 2011.

(51) Int. Cl. G06K 15/02; G06K 15/10; G06T 7/00

(52) U.S. Cl. CPC G06K 15/1872; G06T 7/0004; G06K 15/102
USPC 358/3.26

(57) ABSTRACT

A method for printing and correction of a printed image defects. The method includes inspection of the printed image and detection of segments of printed image that could contain printed defects. Acquisition of printed image and comparison of the acquired image to an error free image being a source of the printed image facilitates detection and correction of the printed image defects.

### TECHNOLOGY FIELD

The present method and apparatus relate to inkjet printing.

### BACKGROUND

Inkjet printing is a non-impact printing technology where a stream of ink droplets is ejected from an inkjet printhead. Usually, the printhead reciprocates over a printing substrate that also can concurrently or intermittently move in a direction perpendicular to the direction in which the printhead moves. The ink droplets ejected towards the substrate form an image on the substrate.

Since inkjet printing is a non-impact printing technology it is used to print on a variety of substrates such as paper, plastics, stone, glass and others. The substrates may come in a variety of sizes for example, inkjet printers for home and small office use print on A4 papers where some industrial printers print on substrates of up to 6000×5000 mm.

In order to enable the handling and display of an image printed on the substrate, in some applications the wet image is cured or dried concurrently with the printing. In other applications, for example, printing on ceramics and glass the printed ink may be fired at a high temperature such that pigments contained in the ink become integral with the substrate.

Like any other technology, inkjet printing is not an error free process. Sometimes excessive ink reaches the substrate and agglomerates into an ink puddle or forms ink drippings, sometimes errors in movement systems and/or inaccurate substrate handling may cause printed image defects. The defects could be such that the printed image becomes unsalable and there it becomes necessary to produce another copy of the same image on the same substrate.

The cost of printing an additional image depends on the size of the image and the size of the substrate, printing time and printer cost, ink and substrate cost. For example, rigid substrates such as glass and polished stones are far more expensive than paper or plastic substrates. In some cases reprinting an image may nullify all of the printing shop on particular job profit and even cause a loss.

### BRIEF SUMMARY

Presented is a method for printing an image on a substrate, acquiring printed image defects and local correction of the printed image defects prior to curing the printed image. The method includes inspection of the printed image and detection and acquisition of segments of the printed image that may contain printed defects.

Inspection of the printed image may further include acquisition of a printed image or printed image segment and comparison of the acquired image or segment to an error free source image or segment to facilitate detection and recognition of printed image defects.

Defects in the printed image may be corrected by erasing a detected/recognized segment of an image containing the defect and reprinting the erased segment of the image.

Also presented is an example of an inkjet printer in which the present method could be implemented.

### BRIEF DESCRIPTION OF THE FIGURES

Examples of the method and apparatus will now be described, by way of non-limiting examples only, with reference to the accompanying drawings, in which:

FIG. 1 is a simplified plan view of an example of a known inkjet printer;

FIG. 2 is a simplified plan view of an example of an inkjet printer in which the present method could be implemented;

FIG. 3 is an example of an ultrasonic ink image erasing device;

FIG. 4 is an example of an ink image ablating device; and

FIG. 5 is an example of a printed image correction process.

### DETAILED DESCRIPTION

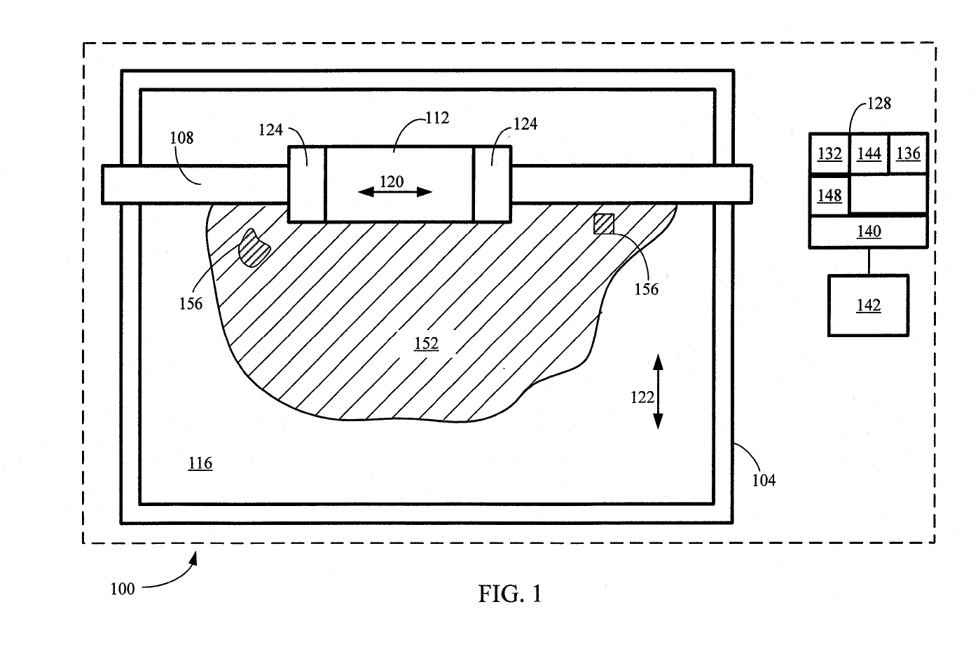

FIG. 1 is a simplified plan view of an example of an existing inkjet printer. Inkjet printer 100 includes a print substrate support 104 and a bridge 108. Print substrate 116 could be a glass plate, a polished marble or granite plate, a metal plate, and a plate made of other materials. A carriage 126 with a printhead 112, which could be an assembly of a plurality of individual printhead modules that could be such modules as Galaxy PH 256/30 printheads or similar, commercially available from FUJIFILM Dimatix, Inc., NH 03766 U.S.A. The particular printheads have 256 piezoelectric ink dispensing elements and the associated mechanical and electrical components for dispensing droplets of ink onto a print substrate 116. Carriage 126 with printhead 112 reciprocates (back and forth movement), as shown by arrow 120 over print substrate 116 mounted or placed on printing substrate support 104. Print substrate support 104 advances print substrate 116 past printhead 112 as shown by arrow 122. Print substrate support 104 could advance substrate 116 past printhead 112 continuously or incrementally, stopping as each swath is printed and then advancing substrate support 104 with substrate 116 for printing the next swath.

Adjacent to printhead 112 are mounted ink drying or solidifying energy sources 124. Drying of ink is usually accomplished by heating air and directing a stream of hot air onto the printed wet ink. Hot air evaporates the fluid component of the ink faster than other methods. In some examples, ink is a radiation curable ink and ink drying energy sources 124 could be replaced by sources of ink curing radiation, for example, ultraviolet (UV) radiation sources. Drying or curing solidifies wet ink and facilitates the later handling of substrate 116 having an image 152 printed onto it.

Printhead 112 could include a large number of individual printhead modules and in one example it could be a stationary printhead that spans the width of print substrate 116 and incorporates thousands of piezoelectric ink dispensing elements. In such printer architecture, print substrate support 104 could be operative to displace substrate 116 in both printing directions 120 and 122. Other printhead configurations and ink dispensing elements are possible.

A control computer or controller 128 in FIG. 1 represents generally a processor 132 and associated memory 136, and the electronic circuitry and components needed to control the operation of printer 100. Control computer 128 includes a keyboard 140 through which different instructions and commands could be entered, and a display 142 that could display the commands as well as images to be printed. Control computer 128 further includes a Raster Image Processor (RIP) 144. RIP 144 receives the digital image to be printed and processes that image into printer control information and printed image data. Control computer 128 controls the movement of carriage 126 and print substrate support 104. Control computer 128 is electrically connected to printhead 112 to energize the piezoelectric ink dispensing elements of the printhead modules to dispense ink droplets on to substrate 108. By coordinating the relative position of printhead 112 and substrate 108 with dispensing ink droplets ejection time, control computer 128 produces the desired image on substrate 108 according to the digital print image data.

A servo system 148 and a pair of encoders (not shown) associated with printhead 112 and substrate support 104 movement directions are providing a reading of printhead 112 and of the image on substrate 108 coordinates. The encoders could provide accurate coordinates of any point or area within the printed image 116. These coordinates could be used for synchronization of the relative position of printhead 112 and substrate 116 with dispensing ink droplets ejection time. The encoders could be of any type, such as linear encoders or rotary encoders as well as magnetic strip encoders.

Like any other technology, inkjet printing is not an error free process. Sometimes excessive ink reaches the substrate and agglomerates into an ink puddle which may result in ink smears or drippings. Inaccurate substrate handling could cause printed image defects. The printed image 152 defects 156, which usually affect a segment of a printed image, could be also caused by excessive ink droplets spontaneously ejected by printhead 112, ink mist accumulated on the nozzle plate and dropped onto the substrate, ink agglomerations caused by ink bleeding and other defects.

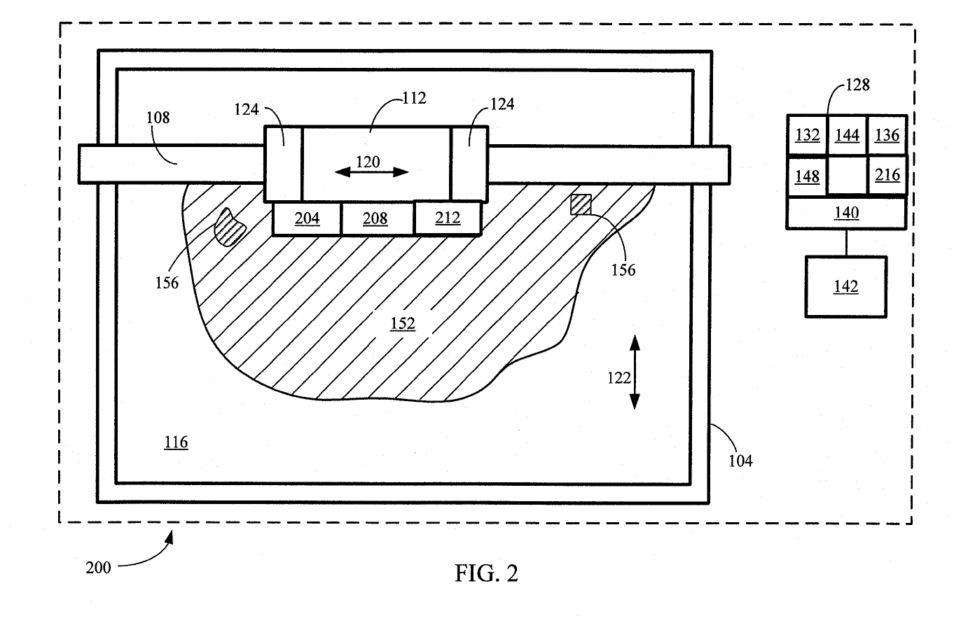

FIG. 2 is a simplified plan view of an example of an inkjet printer in which the present method could be implemented Inkjet printer 200 allows for printed image defects 156 in situ correction. In one example, carriage of inkjet printer 200 also includes a device 204 facilitating inspection of the printed image. Such a device could be a CCD camera or a video camera. Control computer 128 governs operation of device 204. Device 204 instantly (on-line) captures the printed image or a segment of the printed image and provides to control computer 128 the captured image information or data. Control computer 128 could include a dedicated printed circuit board 216 or a program operative to check identicalness of at least a segment of a printed image that includes the defect to a segment of an error free digital image stored in memory 136 of control computer 128. The identicalness between the images could be determined by comparing at least a segment of the printed image data to data of a segment of an error free digital image. Raster Image Processor (RIP) 144 could provide the data of a segment of an error free digital image and CCD camera 204 provides data or information of the captured segment of the printed image. CCD cameras with a large number of pixels such as 1280×960 to 3296×2472 are currently available from a number of vendors and any suitable camera could be employed to capture a segment of the printed image. The information or data on the captured segment of the printed image could be available on a bit map level and it could be compared with a similar level of information or data available from RIP 144.

An image erasing device 208 is also mounted on the carriage. Image erasing device 208 could be an ultrasonic scrapper, a magnetostrictive scrapper, a laser ablation device or combination thereof. Image erasing device 208 is operative to erase a segment of the printed image that includes the defect or the defect only by removing a solidified ink layer from substrate 116. In one example image defect scrapping could be followed by gentle etching of the surface. Adjacent image erasing device 208 could be mounted a vacuum nozzle 212 connected to a source of vacuum (not shown). Vacuum nozzle 212 is operative to suck and remove from substrate 116 and surface of printed image 156 solidified (dry) ink particles that could be present following operation of the image defect erasing device 208.

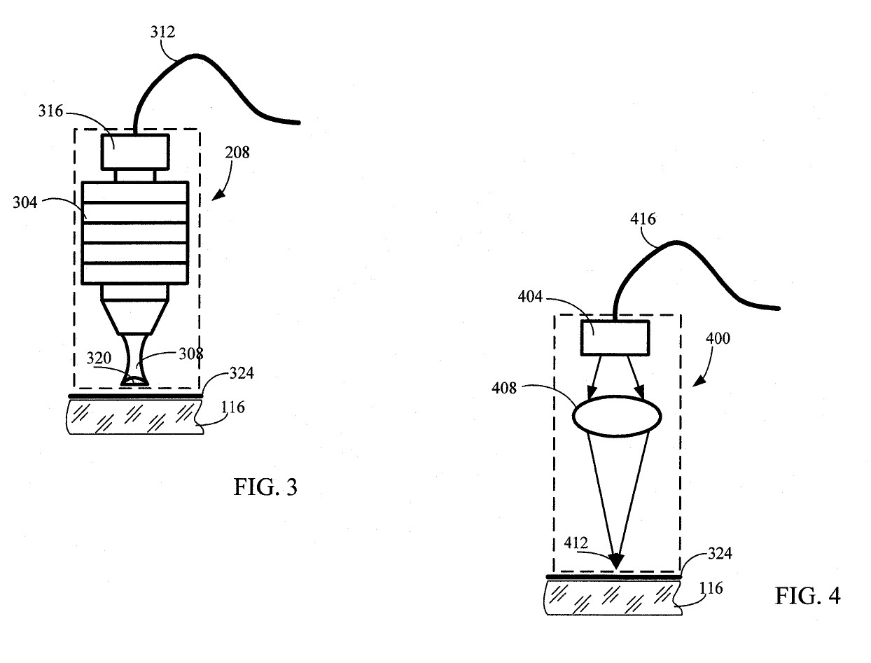

FIG. 3 is an example of an ultrasonic ink image erasing device 208 such as an ultrasonic scrapper. A piezoceramic element 304 or an assembly of piezoceramic elements induces ultrasonic vibrations in a tip 308. A cable 312 connects image erasing device 208 to a driver (not shown) that provides proper electric AC voltage between 10 VRMS to 100 VRMS to piezoceramic element 304 that converts the electrical energy provided by the driver into ultrasonic vibrations. The driver (not shown) could be located proximate to ink image erasing device 208 or in common with control computer 128 packaging. In some examples a balancing weight 316 reducing influence of tip 308 vibrations on the carriage could be a part of ultrasonic image erasing device 208. A sharp edge 320 terminates tip 308.

In order to remove a segment of a printed image containing defect 156 (FIG. 1), sharp edge 320 of tip 308 is applied to a segment of solidified ink layer 324 containing the printed image defect 156. Voltage is supplied to piezoceramic element 304, which in turn vibrates tip 308. Tip 308 vibrations help to destruct and erase or remove the solidified ink particles 324 from substrate 116 surface. In course or image defects removal or erasure, sharp edge 320 of tip 308 could wear. Tip 308 could be a disposable tip, replaced when it is felt that tip edge does not perform proper the solidified ink layer 324 erasure process.

Vacuum nozzle 212 (FIG. 2) becomes operative to suck and remove from substrate 116 and surface of printed image 152 ink particles that could be present following the operation of the image erasing device 208. Cable 312 could also provide a connection to a source of vacuum.

FIG. 4 is an example of a solidified ink image ablating device. Device 400 includes a laser diode 404 or a laser diode array, a lens 408 focusing laser radiation emitted by laser diode 404 into a spot 412. A cable 416 connects laser diode 404 to a diode power supply (not shown) and to control computer 128. In order to remove a printed image defect 156 (FIG. 1), focused laser radiation spot 412 is applied to the printed image defect 156. Laser radiation energy ablates the solidified ink layer 324 from the surface of substrate 116. Vacuum nozzle 212 (FIG. 2) becomes operative to suck and remove from the substrate fumes and debris generated by the ablation process.

In one example, inkjet printhead 112, device 204 facilitating inspection of the printed image and image erasing device 208 are located on the carriage and rigidly fixed to it. The spatial relation or the relative location between them could be calibrated and stored in memory 136. Based on the coordinates of printed image defect 156 (FIG. 1) provided by the feedback loop, control computer 128 could position each of the devices in a proper position to perform a desired operation, which could be erasure of a segment of a printed image that does not correspond to the digital error free image. The digital error free image could be stored in memory 136.

In one example, a drive of device 204, independent from the carriage drive, that facilitates inspection of the printed image and image erasing device 208 could be implemented. The movements of the drive of device 204 facilitating inspection of the printed image and image erasing device 208 could be synchronized and each of them could be located in a proper position to perform a desired operation. Control computer 128 or a servo system could control synchronization of the movement of these devices.

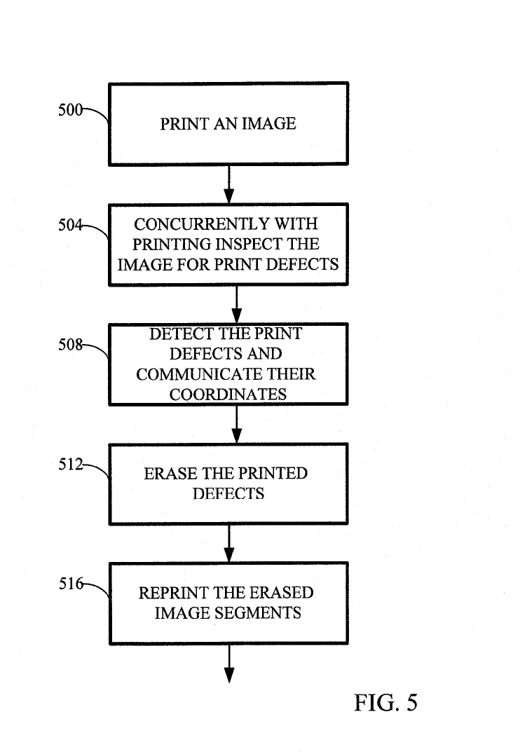

FIG. 5 is an example of a printed image correction process. For printing, substrate 116 on which image 152 is to be printed is placed on print substrate support 104. Printer 200 (FIG. 2) prints image 152 (block 500). Drying or curing device 124 dries or cures the printed image and solidifies the printed ink. Concurrently with image printing, camera 204 scans and captures a segment of a recently printed and solidified image (block 504) although a delay of a desired number of image raster lines could exist. In one example, camera 204 communicates the captured information or data to display 142. Display 142 displays the image and coordinates of the image provided by the encoders and servo system. Printer operator visually inspects the images displayed on display 142 and if a printed image defect is detected or identified, the operator uses keyboard 140 to record coordinates of the defect. Alternatively, the operator could mark by a cursor the segment of image containing the defect. Coordinates of the defect could include at least coordinates of a corner of a segment of image where the defect resides and the size of the defect.

In one example, camera 204 communicates the captured information or data to control computer 128 which could operate a program or a dedicated printed circuit board 216 (FIG. 2) to check identicalness of at least a segment of a printed image to a segment of an error free image to be printed and stored in memory 136 of computer 128. Raster Image Processor (RIP) 144 may provide the data of a segment of an error free image to be printed. Absence of identicalness between the compared images of a segment of a printed image to a segment of an error free image indicates on presence of a printed image defect (block 508).

Practically, the printing could continue until a complete image 152 is printed and additional printed image defects, if such will exist, will be detected. Alternatively, printing of image 152 could be discontinued. The spatial relation between the print head 112, camera 204, and image erasing device 208 has been determined apriori and the control computer 128 locates image erasing device 208 at one of coordinates defining the location of an image segment containing printed image defect 156. In one example the coordinates could include image defect description. Image erasing device 208 becomes operative and erases the segment of the image to be corrected (the segment of the image containing the printed image defect) (block 512). Vacuum nozzle 212 becomes operative and removes solidified and erased ink particles and other debris of the image erasing process.

When printer operator visually detects a printed image defect he or she can manually (by using keyboard 140 to key in appropriate coordinates) locate the image erasing device 208 at one of coordinates determining the location of printed image defect. Image erasing device 208 becomes operative and erases the printed image defect (block 512). Vacuum nozzle 212 becomes operative and removes ink particles and debris of the image erasing process.

Following erasure of the printed image defect 156, control computer 128 resumes the printing process reprinting the erased segment or segments of the printed image 152 and the remaining segments of the image. Once the image is recognized to be defect-free the printed image may be cured.

The printing system and the method disclosed facilitate printed image defects correction saving significant costs associated with potential waste of printing time, substrate and ink cost. The throughput of the printing system is increased and system usage improved.

Additionally, it may be appreciated that the printing system and method disclosed are not limited to printed image defects correction only and may be also employed to implement desired changes in already printed and cured images.

In this case, an original source digital image may be replaced with a digital source image including desired changes. The desired changes may be communicated to a control computer via a feedback loop, which in turn may initiate the erasing and reprinting process as explained hereinabove.

It will be readily appreciated that the present system and method are not limited by the current examples and could be applied to other applications as well. Various modifications and variations can be made in practicing the present method without departing from the spirit or scope of the apparatus and method described. Rather the scope of the present system and method are defined by the scope of the claims.

1. A printed image correction system, said system comprising:
at least one device facilitating inspection of the printed image and providing information regarding identicalness of at least a segment of a printed image to a corresponding segment of an error free image;
a feedback loop providing coordinates of the segment of the printed image corresponding to that of the segment of an error free image; and
an image erasing device, operative to erase a segment of the printed image that does not correspond to the segment of an error free image by removing a solidified ink layer from the printed image.

2. The printing system according to claim 1 further comprising a control computer including at least a processor and a memory and wherein the segment of an error free image resides in said memory.

3. The printing system according to claim 1 further comprising a vacuum nozzle operative to suck and remove from the surface of the image ink particles produced by operation of the image erasing device.

4. The printing system according to claim 1 wherein the device facilitating inspection of the printed image is a CCD or a video camera.

5. The printing system according to claim 1 wherein the device comparing information on identicalness of at least a segment of a printed image to a segment of an error free image is one of a group consisting of a dedicated printed circuit board or a program.

6. The printing system according to claim 1 wherein the image erasing device is one of a group of devices consisting of an ultrasonic scrapper, a magnetostrictive scrapper, and a laser ablation device.

7. The printing system according to claim 1 further comprising a servo system providing a reading of coordinates of the segment of the printed image that are not identical to the error free image, said servo system facilitating the image erasing device positioning.

8. The printing system according to claim 7 wherein the image erasing device positioning is a manual positioning or a computer guided positioning.

9. The printing system according to claim 1 further comprising a printhead operative to eject ink droplets towards a print substrate and form an image on said substrate.

10. The printing system according to claim 1 further comprising ink solidifying energy source and wherein said source is one of a group of sources consisting of hot air and UV curable radiation.

11. The printing system according to claim 1 further comprising a display operative to display at least a segment of a printed image.

12. The printing system according to claim 11 wherein the display is operative to display coordinates of the segment of a printed image.

13. A method for printing and correction of a printed image (defects), said method comprising:
printing an image and inspecting the printed image for print defects;
detecting said printed image defects and identifying at least one segment of the image to be corrected;
erasing the segment of the image containing the print defects by removing a solidified ink layer from the printed image and reprinting the erased segment of the image.

14. The method according to claim 13 wherein said printed image defects are detected by visual inspection of the printed image or by automatic inspection of the printed image.

15. The method according to claim 14 further comprising providing information on at least a segment of a printed image to be compared to a segment of an error free image to a device which is one of a group of a dedicated printed circuit board or a program.

16. The method according to claim 14 wherein erasing the segment of the printed image containing said print defect is by one of a group of image erasing devices consisting of an ultrasonic scrapper, a magnetostrictive scrapper, and a laser ablation device.

17. The method according to claim 16 further comprising applying vacuum to suck and remove solidified ink particles and debris from the surface of the image remaining from operation of the image erasing device.

18. The method according to claim 16 wherein the image erasing device positioning at the segment of printed image to be erased is a manual positioning or a computer guided positioning.

19. The method according to claim 13 further comprising reprinting the erased segment of the image by a printhead operative to eject ink droplets towards a print substrate and form on it an image.

20. The method according to claim 13 further comprising displaying at least a segment of the printed image.

21. The method according to claim 20 further comprising displaying coordinates of the segment of the printed image.

22. A printed image correction system, said system comprising:
at least one inspection device operative to acquire a digital image of at least a segment of a printed image and compare said digital image to an error free source image of a corresponding segment;
a feedback loop operative to provide information regarding detected defects in said acquired digital image when compared to said source image; and
an erasing device operative to receive said information and erase said detected defects by removing a solidified ink layer from the printed image.

23. The system according to claim 22, wherein said information includes at least coordinates of said defects.
